(19) United States
(12) Patent Application Publication
(10) Pub. No.: US 2014/0305884 A1
(43) Pub. Date: Oct. 16, 2014

(54) METHOD AND DEVICE FOR CLEANING WASTEWATER FROM A COKE QUENCHING TOWER WITH SHORTENED CATCH BASIN DWELL TIME

(71) Applicant: ThyssenKrupp Industrial Solutions AG, Essen (DE)

(72) Inventors: Bodo Freimuth, Oberhausen (DE); Klaus Freimuth, Oberhausen (DE)

(21) Appl. No.: 14/359,418

(22) PCT Filed: Oct. 24, 2012
(86) PCT No.: PCT/EP2012/004435

§ 371 Date: May 20, 2014

(30) Foreign Application Priority Data
Nov. 21, 2011 (DE) 10 2011 118 937.1

(51) Int. Cl. C02F 1/38

(52) U.S. Cl. CPC C02F 1/38
USPC 210/787; 210/257.1

(57) ABSTRACT

The present disclosure relates to a process and apparatus for the purification of waste water from a coke quenching tower with reduced residence time in a collecting basin. In the process and apparatus of the present disclosure, water is used for the quenching of hot coke, and the quench water is collected in a collecting basin which is sized such that it is adequate for few quenching operations. The quench water is fed to a downstream hydrodynamic purification device without requiring any additional settling operation. In the purification device, the solids are separated from the quench water by a mechanical separation processes so as to allow a space-saving arrangement of the water collecting basin without a settling basin. The present disclosure also relates to a device configured to perform the disclosed method, which device comprises a quenching tower, a quench water conveying channel for conveying the excess quench water to a collecting basin, a collecting basin, a hydrocyclone, a pleat filter and a centrifuge which is used to separate the solid and the quench water.

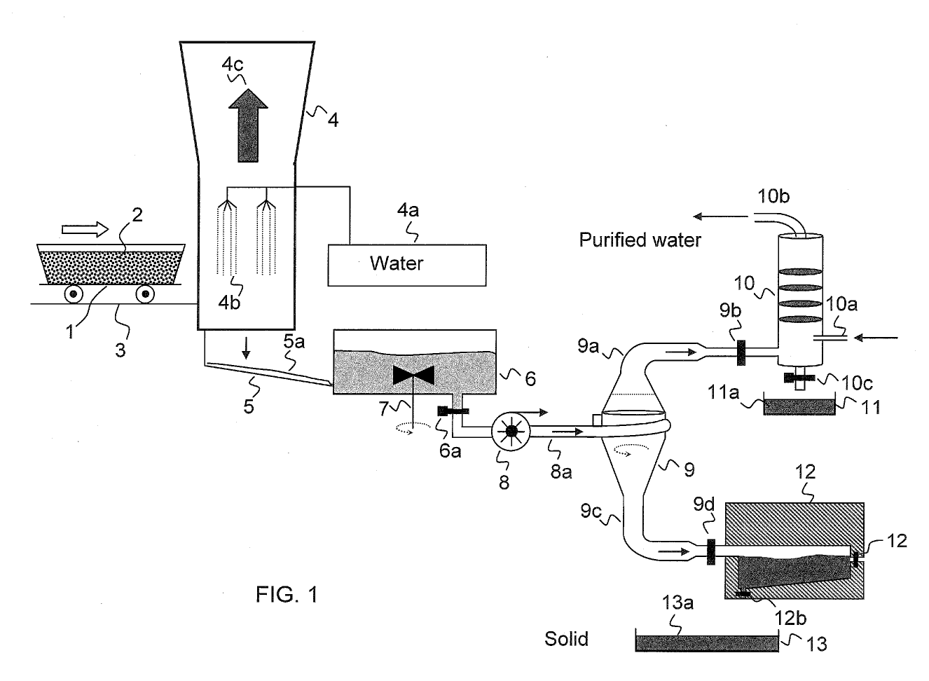

The invention relates to a process for the purification of waste water from a coke quenching tower with reduced residence time in the collecting basin, in which water is used for the quenching of hot coke, and the quench water is collected in a collecting basin which is sized such that it is adequate for few quenching operations, and the quench water is fed to a downstream hydrodynamic purification device without any additional settling operation, in the said purification device the solids being separated from the quench water by mechanical separation processes so to allow a space-saving arrangement of the water collecting basin without settling basin. The invention also relates to an arrangement which consists of a quenching tower, a quench water conveying channel for conveying the excess quench water to a collecting basin, a collecting basin, a hydrocyclone, a pleat filter and a centrifuge which is used to separate the solid and the quench water.

In the production of coke, coal is heated to high temperatures in a coke oven, the volatile constituents of the coal degassing and being collected or burnt. From this process step coke is obtained which is of a temperature of more than 1000° C. after coking and pushed from the coke oven chamber into a coke quenching car provided for this purpose. Depending on the type of coal used, the coke contains more or less large amounts of ash and dust. Normally, the coke is quenched with water in the coke quenching car and thus brought down to a temperature at which the coke can be handled and stored. In almost all common embodiments, the coke quenching car can be moved in parallel along the front side of the coke oven chambers and is normally moved to a quenching station or a quenching tower. An embodiment of a common quenching process is taught in DE1253669B.

When quenching hot coke with water according to the wet quenching process, a large amount of quench water is used spreading it over the glowing coke in a quenching tower provided for this purpose immediately after having pushed the coke out of the coke oven chamber. In so doing, large amounts of water vapour are produced which leave the quenching tower and escape into the atmosphere, mostly visible from afar. As the coke must be cooled down from a temperature of more than 1000° C. to a temperature at which the coke can be processed, water is added in significant excess and in large quantities. The non-evaporated water leaves the quenching tower below the quenching car and is collected in a collecting basin. The quench water is then processed further or disposed of. As the coke also contains ash and dust which are normally of a fine-grained structure, these constituents are washed out of the coke together with the quench water and carried along. For this reason, the quench water must be purified.

WO2004096719A1 describes a process for purifying coke waste water bearing nitrogen compounds, cyanides and sulphides, in which the coke waste water passes through a reactor integrated into a liquid cycle, which is provided with at least one gas-permeable membrane hose, the interior of which is supplied with an oxygenous pressurised gas, and on the exterior of the liquid-immersed membrane hose a biofilm is maintained, in whose inner area—rich in oxygen due to the gas permeability of the membrane hose—nitrogenous compounds contained in the waste water are selectively nitrified to nitrates and at the same time nitrates are denitrified to elemental nitrogen in an oxygen-poor outer area of the biofilm. The process facilitates the purification of coke waste water and is also suitable for the purification of quench water but is still dependent on an efficient solids separation step in particular in the case of waste water containing large amounts of solids.

In prior-art processes the quench water is first fed to a collecting and settling basin in which the solids can settle and sediment. This process step requires much space and time because major part of the solids is of a very fine-grained structure and therefore sediments very slowly. In most cases the quench water thus obtained will not be purified further for cost reasons but is frequently used for the next quenching operation without any further treatment. As part of the fine-grained solid is hence still contained in the quench water in the form of dust, this will result in a considerable additional load of dust during the next quenching operation. Therefore, there has been no lack of attempts to improve the efficiency of the settling step and the subsequent purification steps.

DE3319435A1 describes a process for purifying coke waste water by means of a coke quench water treatment plant consisting of a settling basin and a draining basin which serves for the dewatering of the settled solids and is provided with two or more basins which are alternately charged with coke quench water, each basin serving as draining basin when a specified level of solids is reached and the water inlet has been shut off. This arrangement allows isolating the basin when a certain level has been reached and dewatering the solid almost completely. However, the arrangement requires a lot of space due to the multiple-basin arrangement and dewatering the solid is very time-consuming. Without other measures it is not useful to increase the depth of the basin because the sedimentation velocity as determining parameter is nearly constant.

There is a further search for processes which require considerably less space for the quench water settling basins immediately after the quenching process but still purify the solids-bearing quench water within a justifiable frame of time and economic efficiency.

Therefore it is the objective in the case of coke quench water treatment plants to reduce the number and volume of the settling basins used for excess coke quench water which is obtained as solids-bearing water or as aqueous solids suspension immediately after quenching the hot coke using water.

The invention achieves the objective by a process which first collects the excess quench water during coke quenching in a collecting basin and conveys it immediately after completion of the quenching operation and without any further settling or sedimentation operation by suitable pumps to a hydrodynamic purification device where the water is immediately separated into solid and solids-free water.

The pumps are rated in such a manner that they are also able to convey highly solids-bearing quench water or a quench water suspension without being blocked or damaged by abrasive solids contained in the solid/water suspension. A hydrocyclone which allows rapid separation of an aqueous solids suspension into solid and water is particularly taken into account as hydrodynamic purification device. Solid and water are separated such that the solids are removed from the suspension to such an extent that the purified water can be further used for a quenching process without any further purification. If required, however, the solid obtained or the water purified by means of the hydrocyclone can be purified further at the end of the separation process.

Claim is especially laid to a process for purifying waste water from a coke quenching tower with reduced residence time in the collecting basin, in which
the coke is pushed out of a coke oven, filled in hot state into a coke transport car and sprayed with water in a quenching tower so that the coke is cooled, and
via a conveying device the excess quench water flows into a water collecting device which consists of a water basin as collecting basin, and
the conveying device is provided with a slope by means of which the quench water flows into the water basin without any further external impact,
   and which is characterised in that
the quench water obtained in the water basin flows without any further settling operation into a downstream hydrodynamic purification device in which the solids are separated from the quench water by mechanical separation processes so that it is possible to provide a space-saving arrangement of the water collecting device without settling device.

For implementing the invention, the collecting basin is positioned such that it is located under the quenching tower and the water flows into the collecting basin without applying further conveying. The water is routed through a water-conducting conveying device into the collecting basin. The conveying device is, for example, a quench water conveying channel.

In one embodiment of the invention the purification device includes at least one hydrocyclone used to separate the liquid and solid constituents. Use may be made of a hydrocyclone which in prior art is used for purifying solids-bearing waste water and is well known to the person skilled in the art for waste water treatment. An example of a hydrocyclone suitable for the adequate and rapid separation of solid and water is given in DE102004038125A1. An example of the arrangement for the purification of quench water which includes a suitable hydrocyclone for separating solid and water is given in U.S. Pat. No. 6,641,721B2. For implementing the present invention it is also possible to use several hydrocyclones if the capacity of one hydrocyclone is not sufficient. In such case, the suspension flow of several hydrocyclones may be connected in series or in parallel.

According to the invention it is also possible to use a hydrodynamic purification device which is not a hydrocyclone although the latter is the preferred embodiment. Also conceivable, for example, are a pleat filter, a screening device or a separator. In most cases, this depends on the condition of the solids suspension and the coke oven plant.

In another embodiment of the invention the collecting vessel is equipped with an agitating device. It ensures that no solids deposit in the collecting vessel. As a result, all solid can be fed for separation in suspension to the downstream hydrodynamic purification device.

Normally, the solid/water suspension is fed to the hydrodynamic purification device immediately after the quenching operation. The conveyance to the purification device is preferably carried out by a pump. It must be made and equipped in such that it can convey a highly solids-bearing solids stream, as it is found in the case of ash-bearing and dust-bearing types of coal, with an economically feasible service life and even without any damage. Suitable embodiments of such pumps are taught in WO2004059173A1 and U.S. Pat. No. 4,086,029A. Of course, the pumps can also be used in multiple arrangement.

In most cases, the water freed from solids and leaving the hydrocyclone can be used without any further processing. The separation rate is sufficiently high, in particular if the hydrocyclones are used in multiple arrangement. For specific purposes, however, it may be required to purify the water from the hydrodynamic separation unit further. For example, this will be the case if the water obtained from the purification operation should not be used for further quenching but as service water for plant operation. In one embodiment of the invention the water discharged from the hydrocyclone or the pleat filter is fed to an intermediate vessel from which the water can be used for a further quenching operation. Pleat filters are well known in prior art, a common and suitable embodiment is taught in U.S. Pat. No. 3,799,354A.

The water obtained during the purification process can be used for any further application. In one embodiment of the invention the water purified during the process embodying the invention is used for a further quenching operation. In another embodiment the quench water obtained from the pleat filter is used for a further quenching operation so that a very low dust load can be achieved during a further quenching operation.

The solid obtained during the purification operation can also be used for any further application. In one embodiment of the invention the solid from the hydrocyclone is fed to a centrifuge or a dewatering vessel in which the solid is further dewatered. Intermediate vessels used for storing liquids and solids are feasible at any point of the process, with storage tanks for liquids generally being only used in a way that does not require any more space.

Claim is also laid to a contrivance for purifying waste water from a coke quenching tower with reduced residence time in the settling basin, consisting of an arrangement comprising
a quenching tower for quenching hot coke by spraying with water,
a quench water conveying channel for conveying the excess quench water to a collecting basin,
a collecting basin located below the quench water conveying channel so that the excess quench water flows into the quench water basin by means of the slope,
a pump used for solid/water suspensions, which pumps the solid suspension from the quench water to a downstream hydrocyclone,
a hydrocyclone which is positioned next to the collecting basin and supplied via a pipeline with the solid/water suspension from the settling basin by means of a pump,
a pleat filter to which the water from the hydrocyclone is conveyed and through which the water from the hydrocyclone is to be purified further, and
a centrifuge or a dewatering vessel by means of which the solids sludge can be further dewatered.

The invention has the advantage to facilitate a space-saving arrangement of a purification device for coke quench water and in particular of the collecting or settling basins, and also to facilitate time-saving purification of the solid/water suspension from the excess quench water of a coke quenching operation.

The invention is explained by means of a drawing, this drawing merely representing an exemplary embodiment and not being limited thereto.

A coke quenching car (1) with glowing coke (2) is pushed on a rail (3) underneath a quenching tower (4). After having pushed the quenching car (1) into the quenching tower (4), the coke is sprayed with water (4b) from a quench water tank (4a) in the quenching tower. In so doing, steam (4c) forms which escapes from the quenching tower (4) in upward direction. The excess non-evaporated water (5a) is fed via a quench water conveying channel (5) to a collecting basin (6) which is adequately sized for a maximum of one or two quenching operations. The collecting basin is equipped with an agitating device (7) so that the solids do not deposit in the coke quench water. After completion of the quenching operation the shut-off device (6a) of the collecting basin (6) is opened and the solid/water suspension conveyed via a pipeline (8a) to a hydrocyclone (9) with the aid of a pump (8) suitable for suspensions. The hydrocyclone separates the solid/water suspension into water (9a) and solid (9c) by means of shut-off devices (9b,9d). The water (9a) is fed to a pleat filter (10) where it is completely freed from solids by means of water pressure (10a). This gives a solids-free water (10b) and the solid discharged by means of a valve (10c). The solid obtained (11a) is fed to a storage tank (11). The solid (9c) from the hydrocyclone (9) reaches a dewatering basin (12) where it is completely dewatered. The residual water obtained is discharged by means of an outlet nozzle (12a), just as the dewatered solid (12b). The solid (13a) from the dewatering vessel (12) is fed to a storage tank (13) and can be used for any further application.

### List of Reference Numbers and Designations

1 Coke quenching car
2 Glowing coke
3 Rail
4 Quenching tower
4a Quench water reservoir
4b Water spraying unit
4c Steam
5 quench water conveying channel
5a Excess quench water
6 Collecting basin
6a Shut-off device
7 Agitating device
8 Pump
8a Pipeline
9 Hydrocyclone
9a Water
9b Shut-off device
9c Solid
9d Shut-off device
10 Pleat filter
10a Supply of water pressure
10b Solids-free water
10c Shut-off device for solid
11 Solids storage tank
11a Solid
12 Dewatering vessel
12a Shut-off device
12b Shut-off device for solid
13 Storage tank
13a Solid

What is claimed is:

1.-10. (canceled)

11. A method for purifying waste water from a coke quenching operation, comprising:
spraying hot coke with quenching water in a quenching operation, so as to cool down the hot coke;
by a conveying device, conveying quenching water runoff, from the sprayed quenching water, into a collection device;
conveying the quenching water runoff from the collection device to a hydrodynamic purification device;
by the hydrodynamic purification device, mechanically separating out solids from the quenching water runoff.

12. The method of claim 11, wherein the conveying device is a quench water conveying channel.

13. The method of claim 11, wherein the hydrodynamic purification device includes at least one hydrocyclone used to separate liquid and solid constituents.

14. The method of claim 11, wherein the collection device includes an agitating device.

15. The method of claim 11, wherein the conveying of the quenching water runoff from the collection device to the hydrodynamic purification device is carried out by a pump.

16. The method of claim 13, further comprising:
feeding the quenching water runoff, which has already had solids removed by the hydrocyclone of the hydrodynamic purification device, to a pleat filter for further separation of small particle solids from the quenching water runoff.

17. The method of claim 16, further comprising:
feeding water discharge from at least one of the hydrocyclone or the pleat filter into an intermediate vessel to be used for a further quenching operation.

18. The method of claim 16, further comprising:
spraying quench water runoff, which has been filtered by the pleat filter, onto hot coke in a further quenching operation.

19. The method of claim 13, further comprising:
further dewatering the solids that were previously separated out from the quenching water runoff by the hydrocyclone.

20. The method of claim 19, wherein the further dewatering is performed by at least one of a centrifuge or dewatering vessel.

21. A system for purifying waste water from a coke quenching operation, comprising:
a quenching tower configured to store quenching water for quenching hot coke by spraying the hot coke with the quenching water;
a quench water conveying channel in fluid communication with the quenching tower configured to accept runoff from the sprayed quench water from the quenching tower, wherein the runoff contain a mixture of water and solids;
a collecting basin in fluid communication with and disposed below the quench water conveying channel, configured to collect the runoff from sprayed quench water;
a pump in fluid communication with the collecting basin configured to pump out the quench water runoff collected in the collecting basin;
a downstream hydrocyclone in fluid communication with the pump configured to accept the quench water runoff and mechanically separate solids from the quench water runoff;
a pleat filter in fluid communication with the hydrocyclone and configured to accept quench water runoff discharged from the hydrocyclone and further filter additional solids from the quench water runoff; and
at least one of a centrifuge or dewatering vessel configured to accept the solids that are mechanically separated from the quench water runoff by the hydrocyclone and further dewater the separated solids.
